(19) United States
(12) Patent Application Publication
(10) Pub. No.: US 2015/0022584 A1
(43) Pub. Date: Jan. 22, 2015

(54) INK SET

(71) Applicant: Seiko Epson Corporation, Tokyo (JP)

(72) Inventors: Soichi YAMAZAKI, Shiojiri (JP); Daisuke ISHIHARA, Shiojiri (JP); Hiroaki KUMETA, Matsumoto (JP)

(21) Appl. No.: 14/325,807

(22) Filed: Jul. 8, 2014

(30) Foreign Application Priority Data
Jul. 17, 2013 (JP) 2013-148699

(51) Int. Cl. C09D 11/322; B41J 2/165; C08K 13/00

(52) U.S. Cl. CPC C09D 11/322; C08K 13/00; B41J 2/16505
USPC 347/29; 524/88

(57) ABSTRACT

There is provided an ink set in which at least a cyan ink, a magenta ink, and a yellow ink are provided, each ink provided in the ink set includes water, a pigment of equal to or greater than 5% by mass with respect to 100% by mass of a total amount of each of the ink, glycerin, and a betaine compound having a molecular weight of less than 120, respectively, in each of the ink, a maximum difference in a content ratio of the pigment is equal to or greater than 3.0% by mass, and a maximum difference in a content ratio of the water is equal to or less than 3.0% by mass and in each of the ink, the ink in which a content ratio of the pigment is at a maximum, the ink in which the content ratio of the water is at a maximum, and the ink in which a total content ratio of the glycerin and the betaine compound is at a maximum are the same ink.

### BACKGROUND

1. Technical Field

The present invention relates to an ink set.

2. Related Art

An ink jet recording is a method in which ink droplets are made to fly, and are attached to a recording medium such as paper or a transparent film. In the method, an image with a high-resolution and a high-quality can be recorded at a high speed using a relatively inexpensive apparatus. In such an ink jet recording, a method using a predetermined ink set as means for preventing nozzle omission and ejection deflection, and improving discharging stability is known.

For example, in order to provide an ink set in which the equilibrium of moisture has good consistency over the entire humidity range, the nozzle omission and the ejection deflection can be prevented, reliability is high, and clogging hardly occurs, JP-A-2009-040858 discloses an ink set in which in an ink set formed by combining two or more kinds of ink containing at least a colorant, a wetting agent, and a resin, each of the ink of the ink set includes at least one of different types of wetting agent, the ratio of the difference between the maximum value and the minimum value of the total amount of the wetting agent in each of the ink to the maximum value, and the ratios of the difference between the maximum value and the minimum value of the residual water content at equilibrium with a humidity of 50% RH at a temperature of 23° C. to the maximum value are equal to or less than 5%, respectively.

In addition, in order to provide an ink set capable of forming an excellent image which can form an excellent printed material in which color bleeding does not occur on not only plain paper but also on coated paper for printing coated with an inorganic pigment having a poor water-absorbing property, of which a drying property is excellent, a discharging stability and a storage property are excellent, and in which cockling of the paper does not occur, JP-A-2007-146135 discloses an ink set for recording in which in an ink set of a water-based ink including at least water, a water-insoluble coloring material, a water-soluble organic solvent, and a surfactant, the ink set is formed of at least a black ink, and each of color inks of cyan, magenta, and yellow, 1) the black ink and a water-soluble organic solvent different from at least one kind of the color inks other than the black ink are used, and 2) the surface tension of the water-soluble organic solvent used in only the color inks other than the black ink is higher than the surface tension of the water-soluble organic solvent used in only the black ink.

Incidentally, when the ink is dried after a recording apparatus is left alone for a long period of time, recoverability from nozzle clogging in a case where nozzles are flushed is poor. In addition, when the ink is thickened after the recording apparatus is left alone for a long period of time, the ejection deflection or the like easily occurs, and the discharging stability is poor.

In particular, in a case where a coloring property of the ink set matters, a large amount of the pigment is required to be contained in the ink using a pigment having a relatively low coloring property, and thus a difference in the content ratio of the pigment among each ink provided in the ink set is increased. In this case, an ink of which the content ratio of the pigment in each ink provided in the ink set is larger is more easily dried. In addition, when a head is left for a long period of time in a state in which the head for discharging the ink is capped, a rapid thickening occurs in a particular ink. Therefore, it is more difficult to match a difficulty of drying and a difficulty of thickening among the inks. For this reason, problems of the clogging recoverability and the discharging stability become more significant. Thus, in the related art, there is a trade-off relationship between the improvement of coloring, and the improvement of the clogging recoverability and the discharging stability in the ink set. However, the ink sets as disclosed in JP-A-2009-040858 and JPA-2007-146135 are still insufficient from the viewpoint of improving the clogging recoverability and the discharging stability while maintaining excellent coloring property.

### SUMMARY

An advantage of some aspects of the invention is to provide an ink set of which a coloring property is excellent, and a clogging recoverability and a discharging stability are excellent.

The present inventors repeated thorough studies. As a result, the present inventors found that the above advantages may be achieved by adjusting a composition among each ink provided in the ink set according to the content ratio of a pigment, and thereby completed the invention.

That is, the invention is as follows. [1] An ink set in which at least a cyan ink, a magenta ink, and a yellow ink are provided, each ink provided in the ink set includes water, a pigment of equal to or greater than 5% by mass with respect to 100% by mass of the total amount of each of the ink, glycerin, and a betaine compound having a molecular weight of less than 120, respectively; in each of the ink, a maximum difference in the content ratio of the pigment is equal to or greater than 3.0% by mass, a maximum difference in the content ratio of the water is equal to or less than 3.0% by mass; and among each of the ink, the ink in which the content ratio of the pigment is at a maximum, the ink in which the content ratio of the water is at a maximum, and the ink in which the total content ratio of the glycerin and the betaine compound is at a maximum are the same ink.

[2] The ink set described in [1] further provided with a black ink, in which the black ink includes the water, the pigment of equal to or greater than 5.0% by mass with respect to 100% by mass of the total amount of the black ink, the glycerin, and the betaine compound having a molecular weight of less than 120.

[3] The ink set described in [1] or [2] in which a maximum viscosity difference of each of the ink is equal to or less than 1.0 mPa·s.

[4] The ink set described in any one of [1] to [3] in which at least one of each of the ink further including trimethylolpropane, and among each of the ink, a maximum difference of the total content ratio of the pigment and the trimethylolpropane with respect to 100% by mass of the total amount of each of the ink is equal to or less than 3.0% by mass.

[5] The ink set described in any one of [1] to [4] in which the content ratio of the water in each of the ink is 50% by mass to 60% by mass with respect to 100% by mass of the total amount of each of the ink.

[6] The ink set described in any one of [1] to [5], further including one or more kinds of specific inks, in which the specific ink has color which has difference of equal to or greater than 30° from any of each color that each of the ink has.

[7] An ink jet recording apparatus provided with an ink container which contains the ink set described in any one of [1] to [6], a recording head having nozzles for discharging each ink provided in the ink set, and a cap portion which caps the nozzles with the same cap.

### BRIEF DESCRIPTION OF THE DRAWINGS

The invention will be described with reference to the accompanying drawings, wherein like numbers reference like elements.

FIG. 1 is a perspective view showing a configuration of an ink jet recording apparatus according to the embodiment.

FIG. 2 is a schematic diagram showing rows of nozzle apertures provided to an ink jet head according to the embodiment.

FIG. 3 is a partial cross-sectional view showing an internal configuration of the ink jet head according to the embodiment.

### DESCRIPTION OF EXEMPLARY EMBODIMENTS

Hereinafter, embodiment for carrying out the invention (hereinafter, referred to as “the embodiment”) will be described in detail with reference to the drawings as necessary. The invention is not limited thereto, and various modifications are possible without departing from the gist of the invention. Moreover, in the drawings, the same reference numerals are given to the same elements, and the redundant description will not be repeated. In addition, a positional relationship such as upward, downward, leftward and rightward is based on the positional relationship shown in the drawings unless stated otherwise. Moreover, the dimensional ratio of the drawings is not limited to the ratio shown.

### Ink Set

The ink set according to the embodiment is provided in which at least a cyan ink, a magenta ink, and a yellow ink are provided, each ink provided in the ink set includes water, a pigment of equal to or greater than 5% by mass with respect to 100% by mass of the total amount of each of the ink, glycerin, and a betaine compound having a molecular weight of less than 120, respectively; in each of the ink, a maximum difference between the content ratio of the pigment is equal to or greater than 3.0% by mass, and a maximum difference in the content ratio of the water is equal to or less than 3.0% by mass; and among each of the ink, the ink in which the content ratio of the pigment is at a maximum, the ink in which the content ratio of the water is at a maximum, and the ink in which the total content ratio of the glycerin and the betaine compound is at a maximum are the same ink.

In the ink set according to the embodiment, even when a maximum difference in the content ratio of the pigment among each ink provided in the ink set is equal to or greater than 3.0% by mass, the clogging recoverability and the discharging stability of the ink set are excellent. For example, most cyan pigments have an excellent coloring property even with a small amount of the cyan pigment, in contrast, most magenta pigments do not have the excellent coloring property, and thus in order to make the magenta pigment have the excellent coloring property, it is necessary to use a large amount of the pigment. For this reason, in order to improve the coloring property of the entire ink set, it is necessary for the maximum difference of the pigment to be equal to or greater than 3.0% by mass.

Hereinafter, the ink set having the excellent clogging recoverability and the discharging stability will be further described. Usually, in the ink jet recording apparatus, the conditions relating to discharge are not set for each color of ink, and thus when there is a difference in the viscosity of each color of ink provided in the ink set, a discharge speed of one ink is relatively fast, and a discharge speed of the other ink is relatively slow. Therefore stable discharge cannot be achieved. For this reason, it is preferable to arrange the physical properties among each ink provided in the ink set. However, even though the physical properties among each ink are matched at the time of manufacturing the inks, when the inks are dried or thickened over time, variation occurs in the physical properties among each of the ink, and therefore, stable discharge cannot be achieved in some cases. This is due to the fact that changes in the physical properties over time vary depending on a concentration of the pigment included in the inks. According to the ink set of the embodiment, by having the above configuration, it is possible to reduce the difference in drying or thickening among the inks. Thus, the clogging recoverability and the discharging stability of the ink set become excellent.

The glycerin and the betaine compound having a molecular weight of less than 120 can act as a moisturizing agent in a black ink described later, in addition to the cyan ink, the magenta ink, and the yellow ink. By using a combination of the glycerin and the betaine compound having a molecular weight of less than 120, the clogging recoverability and the discharging stability of the ink set become excellent. By using a combination of the glycerin and the betaine compound having a molecular weight of less than 120, a low viscosity, a high moisture retaining property, and the discharging stability can be ensured. It is believed that since these compounds with a low molecular weight have a plurality of strong polar groups and hydrophilic groups, by using a combination of the glycerin and the betaine compound having a molecular weight of less than 120, a higher dispersion stability of the ink than used alone can be ensured.

Moreover, the cyan ink, the magenta ink, and the yellow ink are included in the “each of the ink provided in the ink set”, and in a case where the ink set is provided with the black ink described later and a specific ink, these inks are also included in the “each of the ink provided in the ink set”.

The ink set according to the embodiment is provided with at least the cyan ink, the magenta ink, and the yellow ink, and may further provided with the black ink and the specific ink. Hereinafter, each of the ink will be described.

### Cyan Ink

The cyan ink includes water, a pigment of equal to or greater than 5% by mass with respect to 100% by mass of the total amount of the cyan ink, glycerin, and a betaine compound having a molecular weight of less than 120, respectively. Examples of the pigment used in the cyan ink, which are not particularly limited, include C. I. Pigment Blue 1, 2, 3, 15, 15:1, 15:2, 15:3, 15:34, 15:4, 16, 18, 22, 25, 60, 65 and 66, and C. I. Vat Blue 4 and 60.

The content ratio of the pigment included in the cyan ink is equal to or greater than 5% by mass, and preferably equal to or greater than 5.5% by mass, and more preferably equal to or greater than 6% by mass with respect to 100% by mass of the total amount of the cyan ink. When the content ratio of the pigment is equal to or greater than 5% by mass, the coloring property of the ink set is more excellent. In addition, the content ratio of the pigment included in the cyan ink is preferably equal to or less than 12% by mass, and more preferably equal to or less than 10% by mass, and even more preferably equal to or less than 7% by mass with respect to 100% by mass of the total amount of the cyan ink. When the content ratio of the pigment is equal to or less than 12% by mass, there is a tendency that coloring, the reduction of the viscosity, the clogging recoverability, and the discharging stability are more excellent.

As the water included in the cyan ink, which is not particularly limited, for example, pure water such as ion exchange water, ultra filtration water, reverse osmosis water and distilled water, or ultra pure water are preferably used. In particular, there is a tendency that when the water is sterilized by irradiation with an ultraviolet ray or adding hydrogen peroxide, generation of fungi or bacteria is further prevented over a long period of time.

The content ratio of the water included in the cyan ink is preferably 50% by mass to 60% by mass with respect to 100% by mass of the cyan ink. When the content ratio of the water is within the above-described range, there is a tendency that the coloring, the clogging recoverability, the discharging stability, and the suppression of curl are more excellent.

The content ratio of the glycerin included in the cyan ink is preferably 3% by mass to 20% by mass, more preferably 3% by mass to 10% by mass, and even more preferably 4% by mass to 10% by mass with respect to 100% by mass of the cyan ink. When the content ratio of the glycerin is within the above-described range, there is a tendency that the discharging stability, an ink drying property, and fixation are more excellent.

As the betaine compound having a molecular weight of less than 120 included in the cyan ink, which is not particularly limited, trimethyl glycine, dimethyl glycine, and glycine are exemplified. The content ratio of the betaine compound included in the cyan ink is preferably 3% by mass to 20% by mass, more preferably 5% by mass to 15% by mass, and even more preferably 7% by mass to 13% by mass with respect to 100% by mass of the cyan ink. When the content ratio of the betaine compound is within the above-described range, there is a tendency that the suppression of drying and thickening of the ink, the discharging stability, and suppression of curl are more excellent.

### Magenta Ink

The magenta ink includes water, a pigment of equal to or greater than 5% by mass with respect to 100% by mass of the total amount of the magenta ink, glycerin, and a betaine compound having a molecular weight of less than 120, respectively. Examples of the pigment used in the magenta ink, which are not particularly limited, include C. I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 53, 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, or C. I. Pigment Violet 19, 23, 32, 33, 36, 38, 43, and 50.

The content ratio of the pigment included in the magenta ink is equal to or greater than 5% by mass, preferably equal to or greater than 7% by mass, and more preferably equal to or greater than 8% by mass with respect to 100% by mass of the total amount of the magenta ink. When the content ratio of the pigment is equal to or greater than 5% by mass, the coloring property of the ink set is more excellent. In addition, the content ratio of the pigment included in the magenta ink is preferably equal to or less than 13% by mass, more preferably equal to or less than 11% by mass, and even more preferably equal to or less than 10% by mass with respect to 100% by mass of the total amount of the magenta ink. When the content ratio of the pigment is equal to or less than 13% by mass, there are tendencies that coloring, the reduction of the viscosity, the clogging recoverability, and the discharging stability are more excellent.

As the water included in the magenta ink, the same water as the water that can be used in the cyan ink is exemplified. The content ratio of the water included in the magenta ink is preferably 50% by mass to 60% by mass with respect to 100% by mass of the magenta ink. When the content ratio of the water is within the above-described range, there is a tendency that the coloring, the clogging recoverability, the discharging stability, and the suppression of curl are more excellent.

The content ratio of the glycerin included in the magenta ink is preferably 3% by mass to 20% by mass, more preferably 3% by mass to 10% by mass, and even more preferably 4% by mass to 10% by mass with respect to 100% by mass of the magenta ink. When the content ratio of the glycerin is within the above-described range, there is a tendency that the discharging stability, the ink drying property, and fixation are more excellent.

As the betaine compound included in the magenta ink, the same betaine compound as the betaine compound that can be used in the cyan ink is exemplified. The content ratio of the betaine compound included in the magenta ink is preferably 3% by mass to 20% by mass, more preferably 5% by mass to 15% by mass, and even more preferably 7% by mass to 13% by mass with respect to 100% by mass of the magenta ink. When the content ratio of the betaine compound is within the above-described range, there is a tendency that the suppression of drying and thickening of the ink, the discharging stability, and suppression of curl are more excellent.

### Yellow Ink

The yellow ink includes water, a pigment of equal to or greater than 5% by mass with respect to 100% by mass of the total amount of the yellow ink, glycerin, and a betaine compound having a molecular weight of less than 120, respectively. Examples of the pigment used in the yellow ink, which are not particularly limited, include C. I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

The content ratio of the pigment included in the yellow ink is equal to or greater than 4% by mass, and preferably equal to or greater than 5% by mass, and more preferably equal to or greater than 6% by mass with respect to 100% by mass of the total amount of the yellow ink. When the content ratio of the pigment is equal to or greater than 5% by mass, the coloring property of the ink set is more excellent. In addition, the content ratio of the pigment included in the yellow ink is preferably equal to or less than 13% by mass, more preferably equal to or less than 10% by mass, and even more preferably equal to or less than 8% by mass with respect to 100% by mass of the total amount of the yellow ink. When the content ratio of the pigment is equal to or less than 10% by mass, there are tendencies that coloring, the reduction of the viscosity, the clogging recoverability, and the discharging stability are more excellent.

As the water included in the yellow ink, the same water as water that can be used in the cyan ink is exemplified. The content ratio of the water included in the yellow ink is 50% by mass to 60% by mass with respect to 100% by mass of the yellow ink. When the content ratio of the water is within the above-described range, there are tendencies that the coloring, the clogging recoverability, the discharging stability, and the suppression of curl are more excellent.

The content ratio of the glycerin included in the yellow ink is preferably 3% by mass to 20% by mass, more preferably 3% by mass to 10% by mass, and even more preferably 4% by mass to 10% by mass with respect to 100% by mass of the yellow ink. When the content ratio of the glycerin is within the above-described range, there is a tendency that the discharging stability, the ink drying property, and fixation are more excellent.

As the betaine compound included in the yellow ink, the same betaine compound as the betaine compound that can be used in the cyan ink is exemplified. The content ratio of the betaine compound included in the yellow ink is preferably 3% by mass to 20% by mass, more preferably 5% by mass to 15% by mass, and even more preferably 7% by mass to 13% by mass with respect to 100% by mass of the yellow ink. When the content ratio of the betaine compound is within the above-described range, there is a tendency that the suppression of drying and thickening of the ink, the discharging stability, and suppression of curl are more excellent.

### Black Ink

The ink set according to the embodiment can be further provided with a black ink. The black ink includes water, a pigment of equal to or greater than 5% by mass with respect to 100% by mass of the total amount of the black ink, glycerin, and a betaine compound having a molecular weight of less than 120, respectively. As the pigment included in the black ink, which is not particularly limited, a carbon black is exemplified. Examples of the carbon black used for the black ink, which are not particularly limited, include No. 2300, No. 900, MCF 88, No. 33, No. 40, No. 45, No. 52, MA 7, MA 8, MA 100, No. 2200B and the like (hereinbefore, manufactured by Mitsubishi Chemical Corporation), Raven 5750, Raven 5250, Raven 5000, Raven 3500, Raven 1255, Raven 700 and the like (hereinbefore, manufactured by Columbia carbon Ltd.), Regal 400R, Regal 330R, Regal 660R, Mogul L, Monarch 700, Monarch 800, Monarch 880, Monarch 900, Monarch 1000, Monarch 1100, Monarch 1300, Monarch 1400 and the like (manufactured by CABOT JAPAN K. K.), Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A and Special Black 4 (hereinbefore, manufactured by Degussa).

The content ratio of the pigment capable of being included in the black ink is preferably equal to or greater than 5% by mass, more preferably equal to or greater than 6% by mass, and even more preferably equal to or greater than 7% by mass with respect to 100% by mass of the total amount of the black ink. When the content ratio of the pigment is equal to or greater than 5% by mass, there is a tendency that the coloring property of the ink set is more excellent. In addition, the content ratio of the pigment capable of being included in the black ink is preferably equal to or less than 15% by mass, more preferably equal to or less than 13% by mass, and even more preferably equal to or less than 11% by mass with respect to 100% by mass of the total amount of the black ink. When the content ratio of the pigment is equal to or less than 15% by mass, there is a tendency that coloring, the reduction of the viscosity, the clogging recoverability, and the discharging stability are more excellent.

As the water capable of being used in the black ink, the same water as water that can be used in the cyan ink is exemplified. The content ratio of the water included in the black ink is 50% by mass to 60% by mass with respect to 100% by mass of the black ink. When the content ratio of the water is within the above-described range, there is a tendency that the coloring, the clogging recoverability, the discharging stability, and the suppression of curl are more excellent.

The content ratio of the glycerin capable of being included in the black ink is preferably 3% by mass to 20% by mass, more preferably 3% by mass to 10% by mass, and even more preferably 4% by mass to 10% by mass with respect to 100% by mass of the black ink. When the content ratio of the glycerin is within the above-described range, there is a tendency that the discharging stability, the ink drying property, and fixation are more excellent.

As the betaine compound included in the black ink, the same betaine compound as the betaine compound that can be used in the cyan ink is exemplified. The content ratio of the betaine compound included in the black ink is preferably 3% by mass to 20% by mass, more preferably 5% by mass to 15% by mass, and even more preferably 7% by mass to 13% by mass with respect to 100% by mass of the black ink. When the content ratio of the betaine compound is within the above-described range, there is a tendency that the suppression of drying and thickening of the ink, the discharging stability, and suppression of curl are more excellent.

### Specific Ink

The ink set according to the embodiment can be further provided with one or more kinds of specific inks. The specific ink preferably has color which has a difference of equal to or greater than 30° from any of each color that the cyan ink, the magenta ink, the yellow ink, and the black ink capable of being provided have. As the specific ink, an orange ink, a red ink, a green ink, and a blue ink are exemplified. Moreover, color can be measured by a spectral colorimeter, a spectrophotometer, and a color-difference meter.

Examples of the pigment capable of being used in a case where the specific ink is the orange ink, which are not particularly limited, include C. I. Pigment Orange 1, 2, 5, 7, 13, 14, 15, 16, 24, 34, 36, 38, 40, 43 and 63.

Examples of the pigment capable of being used in a case where the specific ink is the red ink, which are not particularly limited, include a red pigment of the above-described magenta ink, and a mixed pigment of the above-described magenta ink and the above-described yellow ink.

Examples of the pigment capable of being used in a case where the specific ink is the green ink, which are not particularly limited, include C. I. Pigment Green 7, 10, and 36.

Examples of the pigment capable of being used in a case where the specific ink is the blue ink, which are not particularly limited, include a blue pigment of the above-described cyan ink, and a mixed pigment of the above-described cyan ink and magenta ink.

The content ratio of the pigment capable of being included in the specific ink is preferably equal to or greater than 4% by mass, more preferably equal to or greater than 5% by mass, and even more preferably equal to or greater than 6% by mass. When the content ratio of the pigment is equal to or greater than 4% by mass, there is a tendency that the coloring property of the ink set is more excellent. In addition, the content ratio of the pigment included in the specific ink is preferably equal to or less than 15% by mass, more preferably equal to or less than 12% by mass, and even more preferably equal to or less than 10% by mass. When the content ratio of the pigment is equal to or less than 15% by mass, there is a tendency that coloring, the reduction of the viscosity, the clogging recoverability, and the discharging stability are more excellent.

The specific ink may include water. As the water capable of being used in the specific ink, the same water as water that can be used in the cyan ink is exemplified. The content ratio of the water included in the specific ink is preferably 50% by mass to 60% by mass with respect to 100% by mass of the specific ink. When the content ratio of the water is within the above-described range, there is a tendency that the coloring, the clogging recoverability, the discharging stability, and the suppression of curl are more excellent.

The specific ink may include glycerin. The content ratio of the glycerin capable of being included in the specific ink is preferably 3% by mass to 20% by mass, more preferably 3% by mass to 10% by mass, and even more preferably 4% by mass to 10% by mass with respect to 100% by mass of the specific ink. When the content ratio of the glycerin is within the above-described range, there is a tendency that the discharging stability, the ink drying property, and fixation are more excellent.

The specific ink may include a betaine compound having a molecular weight of less than 120. As the betaine compound included in the specific ink, the same betaine compound as the betaine compound that can be used in the cyan ink is exemplified. The content ratio of the betaine compound included in the specific ink is preferably 3% by mass to 20% by mass, more preferably 5% by mass to 15% by mass, and even more preferably 7% by mass to 13% by mass with respect to 100% by mass of the specific ink. When the content ratio of the betaine compound is within the above-described range, there is a tendency that the suppression of drying and thickening of the ink, the discharging stability, and suppression of curl are more excellent.

### Difference of Content Ratio of Pigment

When the coloring property matters, a maximum difference in the content ratio of the pigment among the cyan ink, the magenta ink, the yellow ink, and the black ink and the specific ink capable of being provided in the ink set is equal to or greater than 3.0% by mass. Even when a maximum difference in the content ratio of the pigment in each ink is equal to or greater than 3.0% by mass, the clogging recoverability and the discharging stability of the ink set become excellent by adjusting a moisturizing agent and a water content of the invention. In addition, the maximum difference in the content ratio of the pigment in each ink is preferably equal to or less than 10% by mass, more preferably equal to or less than 7% by mass, and even more preferably equal to or less than 5% by mass. When the difference in the content ratio of the pigment is equal to or less than 10% by mass, there is a tendency that differences among colors in the suppression of drying and thickening of the ink and the discharging stability are decreased.

### Difference of Content Ratio of Water

A maximum difference of the content ratio of water is equal to or less than 3.0% by mass, preferably equal to or less than 2.0% by mass, and more preferably equal to or less than 1.0% by mass among the cyan ink, the magenta ink, the yellow ink, and the black ink and the specific ink capable of being provided in the ink set. When the maximum difference in the content ratio of the water in each ink is equal to or less than 3.0% by mass, differences among colors in the suppression of drying and thickening of the ink, and the discharging stability are easily decreased. In addition, the lower limit of the difference in the content ratio of the water in each ink, which is not particularly limited, is preferably equal to or greater than 0% by mass.

In the ink set according to the embodiment, among the cyan ink, the magenta ink, the yellow ink, and the black ink and the specific ink capable of being provided in the ink set, the ink in which the content ratio of the pigment is at a maximum, the ink in which the content ratio of the water is at a maximum, and the ink in which the total content ratio of the glycerin and the betaine compound is at a maximum are the same ink. Thus, the ink which is easily dried becomes less likely to be dried, and differences among colors in the suppression of drying and thickening of the ink and the discharging stability are decreased.

### Difference of Viscosity

A maximum difference in the viscosity of the cyan ink, the magenta ink, the yellow ink, and the black ink and the specific ink capable of being provided in the ink set is preferably equal to or less than 1.0 mPa·s, more preferably equal to or less than 0.5 mPa·s, even more preferably equal to or less than 0.2 mPa·s. When the maximum difference in the viscosity of each ink is equal to or less than 1.0 mPa·s, there is a tendency that the difference in the discharging properties among the inks is decreased, and thus, image quality is excellent. Moreover, the viscosity can be measured by the methods described in the examples.

### Additive

The cyan ink, the magenta ink, the yellow ink, and the black ink and the specific ink capable of being provided in the ink set may include other additives. Examples of the other additive, which are not particularly limited, include trimethylolpropane, a resin, a penetrating agent, a moisturizing agent, a surfactant, pyrrolidone derivatives, and a pH adjusting agent.

### Trimethylolpropane

The cyan ink, the magenta ink, the yellow ink, and the black ink and the specific ink capable of being provided in the ink set preferably further include the trimethylolpropane. According to an aspect of the invention, in the same manner as the pigment, it was found that the trimethylolpropane has a low moisture retaining property and a high viscosity-increasing effect. When the trimethylolpropane is included, there is a tendency that, in the ink in which a small amount of pigment is contained, and even in the ink more difficult to be evaporated than the ink in which a large amount of pigment is contained, difference in the viscosity from other inks is decreased without increasing a moisture retaining property. The maximum difference of total content ratio of the pigment and the trimethylolpropane with respect to 100% by mass of the total amount of each ink is preferably equal to or less than 3.0% by mass, more preferably equal to or less than 2.0% by mass, and even more preferably equal to or less than 1.0% by mass among the cyan ink, the magenta ink, the yellow ink, and the black ink and the specific ink capable of being provided in the ink set. When the difference of total content ratio of the pigment and the trimethylolpropane is equal to or less than 3.0% by mass, there is a tendency that differences among colors in a viscosity and a moisturizing capacity of the ink are decreased.

### Resin

Each ink used in the embodiment preferably further includes a resin. As the resin, for example, a resin in which a polymer component is dispersed or dissolved in a solvent in the form of an emulsion can be used. Among these, a resin dispersed or dissolved in the form of an emulsion is preferable. There is a tendency that by using such a resin, a recorded material having excellent waterfastness and abrasion resistance can be obtained. Examples of the resin, which are not particularly limited, include an acrylic resin, a vinyl acetate resin, a vinyl chloride resin, a butadiene resin, a styrene resin, a polyester resin, a crosslinked acrylic resin, a crosslinked styrene resin, a benzoguanamine resin, a phenolic resin, a silicone resin, an epoxy resin, a urethane resin, a paraffin resin, a fluorine resin, and a water-soluble resin, and copolymers in which monomers constituting these resins are combined. Examples of the copolymer, which are not particularly limited, include a styrene-butadiene resin and a styrene-acrylic resin. In addition, as the resin, polymer latex including these resins can be used. As the polymer latex, polymer latex including fine particles of an acrylic resin, a styrene-acrylic resin, a styrene resin, a crosslinked acrylic resin, and a crosslinked styrene resin can be exemplified.

Among these, the acrylic resin, the urethane resin, the polyester resin, and a water-soluble resin, and copolymers in which monomers constituting these resins are combined are preferable, and a copolymer of the acrylic resin is more preferable. There is a tendency that by using such a resin, the abrasion resistance of the obtained recorded material is further improved.

As the acrylic resin, which is not particularly limited, for example, acrylic resins polymerized from acrylate or acrylic acid and other monomers are preferable, and styrene-acrylic resins such as a styrene-acrylic acid copolymer using styrene as another monomer are more preferable.

Moreover, these resins may be used singly or in combination of two or more kinds thereof.

### Penetrating Agent

Each ink used in the embodiment preferably further contains a penetrating agent. A recorded material in which bleeding of an image is small can be obtained by fast penetration of the ink into a cloth.

As the penetrating agent, which is not particularly limited, alkyl ethers of polyol (glycol ethers) and 1,2-alkyldiol are preferably exemplified. Examples of the glycol ether, which are not particularly limited, include ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, triethylene glycol monobutyl ether, 1-methyl-1-methoxy butanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, propylene glycol monobutyl ether and dipropylene glycol monobutyl ether. In addition, examples of the 1,2-alkyldiol, which are not particularly limited, include 1,2-pentanediol and 1,2-hexanediol. In addition to these, diols having a linear hydrocarbon such as 1,3-propanediol, 1,4-butanediol, 1,5-pentanediol, 1,6-hexanediol, 1,7-heptanediol and 1,8-octanediol can also be exemplified.

The penetrating agent may be used alone or two or more kinds may be used in combination.

The content ratio of the penetrating agent is preferably 0.1% by mass to 20% by mass, and more preferably 0.5% by mass to 10% by mass with respect to the total mass (100% by mass) of each ink. When the content ratio is equal to or greater than 0.1% by mass, the penetration into a cloth of the ink can be increased. In contrast, when the content ratio is equal to or less than 20% by mass, generation of bleeding in an image can be prevented, and the viscosity of the ink can be made not to be high.

### Moisturizing Agent

In addition to glycerin, a betaine compound having a molecular weight of less than 120, and trimethylolpropane, the ink used in the embodiment preferably further includes a moisturizing agent. The moisturizing agent can be used without being particularly limited as long as it is generally used in the ink jet ink. The boiling point of the moisturizing agent is preferably equal to or greater than 180° C., and more preferably equal to or greater than 200° C. When the boiling point is within the above-described range, an excellent water holding property and a wetting property can be applied to the ink.

Specific examples of the moisturizing agent having a high boiling point, which are not particularly limited, include ethylene glycol, propylene glycol, diethylene glycol, triethylene glycol, pentamethylene glycol, trimethylene glycol, 2-butene-1,4-diol, 2-ethyl-1,3-hexanediol, 2-methyl-2,4-pentanediol, tripropylene glycol, polyethylene glycol having a number average molecular weight of 2,000 or lower, 1,3-propylene glycol, isopropylene glycol, isobutylene glycol, meso-erythritol, and pentaerythritol.

The moisturizing agent may be used alone or two or more kinds may be used in combination. When the ink includes the moisturizing agent having a high boiling point, it is possible to obtain the ink which can maintain fluidity and redispersibility for a long period of time even if the ink is left in a state where the pigment ink is exposed to air in an open state. Furthermore, in such an ink, since the clogging of nozzles is unlikely to occur while printing is performed using the ink jet recording apparatus or at the time of being restarted after an interruption, the discharging stability of the ink becomes excellent. The content ratio of the above-described moisturizing agent is preferably 3% by mass to 30% by mass. When the content ratio is within the above-described range, there is tendency that the moisture retaining property is excellent, and thus evaporation is unlikely to occur.

### Surfactant

The ink used in the embodiment preferably includes a surfactant. As the surfactant, which is not particularly limited, for example, at least one of acetylene glycol-based surfactants and polysiloxane-based surfactants are preferable. When the ink includes these surfactants, the drying property of the ink attached to a cloth becomes more excellent, and high-speed printing becomes possible.

Among these, the polysiloxane-based surfactants are more preferable since the solubility in the ink is increased and foreign matter in the ink is unlikely to be generated.

As the acetylene glycol-based surfactants and the acetylene glycol-based surfactants, which are not particularly limited, one or more kinds selected from 2,4,7,9-tetramethyl-5-decyne-4,7-diol and alkylene oxide adducts of 2,4,7,9-tetramethyl-5-decyne-4,7-diol, and 2,4-dimethyl-5-decyne-4-ol and alkylene oxide adducts of 2,4-dimethyl-5-decyne-4-ol are preferable. As these, E series (product name, manufactured by Air Products Japan, Inc.) of Olfine 104 series and Olfine E1010, and, Surfynol 465 and Surfynol 61 (product names, manufactured by Nissin Chemical Industry Co., Ltd.) are exemplified.

In addition, as the polysiloxane-based surfactants, which are not particularly limited, BYK-347 and BYK-348 (product names, manufactured by BYK Japan KK) are exemplified.

The content ratio of the above-described surfactants is preferably 0.1% by mass to 3.0% by mass with respect to the total mass (100% by mass) of the ink.

### Pyrrolidone Derivative

The ink used in the embodiment preferably includes a pyrrolidone derivative. The pyrrolidone derivative can be preferably used from the viewpoint of reducing clogging or discharging defects by suppressing drying and solidification of the ink on a nozzle surface of the head. Examples of the pyrrolidone derivative, which are not particularly limited, include N-methyl-2-pyrrolidone, N-ethyl-2-pyrrolidone, N-vinyl-2-pyrrolidone, 2-pyrrolidone, N-butyl-2-pyrrolidone, and 5-methyl-2-pyrrolidone. When the pyrrolidone derivative is included, the content ratio thereof is preferably equal to or greater than 1% by mass and equal to or less than 10% by mass with respect to the total mass of a first ink.

### pH Adjusting Agent

The ink used in the embodiment preferably includes a pH adjusting agent. The pH adjusting agent can easily adjust a pH of the ink. Examples of the pH adjusting agent, which are not particularly limited, include inorganic acids (for example, sulfuric acid, hydrochloric acid, and nitric acid), inorganic bases (for example, lithium hydroxide, sodium hydroxide, potassium hydroxide, and ammonia), organic bases (triethanolamine, diethanolamine, monoethanolamine, and tripropanolamine), and organic acids (for example, adipic acid, citric acid, and succinic acid). The pH adjusting agent may be used alone or two or more kinds may be used in combination.

The content ratio of the pH adjusting agent is preferably 0.05% by mass to 3% by mass. When the content ratio of the pH adjusting agent is within the above-described range, there is a tendency that charge repulsion of the pigment is excellent and pigment dispersion is excellent.

### Other Components

In the ink used in the embodiment, various additives such as a solubilizer, a viscosity modifier, moisturizing agent, a pH adjusting agent, an antioxidant, a preservative, an antifungal agent, a corrosion inhibitor and a chelating agent for capturing metal ions which affect dispersion can be suitably added in order to maintain the storage stability thereof and the discharging stability of the head to be excellent, to improve the clogging or to prevent deterioration of the ink.

### Ink Jet Recording Apparatus

The ink jet recording apparatus according to the embodiment is provided with an ink container which contains the ink set according to the embodiment, a recording head having nozzles for discharging each ink provided in the ink set, and a cap portion which caps the nozzles with the same cap. When the unused state of the recording apparatus continues for several months to several years, the difference in the water evaporation and the water absorption among colors of the inks inevitably occurs, and therefore, the invention with such a configuration is particularly useful as the clogging measures of a specific nozzle.

In a case of being stored in the same cap for a long period of time, the water evaporation occurs from particularly the ink which is easily evaporated, and the water absorption occurs in the ink which is relatively difficult to be evaporated. In addition, in reducing the evaporation difference among the ink colors, not only absolute evaporation and hygroscopicity of the ink but also relative evaporation and hygroscopicity among the ink colors are strongly related.

In a case where the coloring matters, difference in the amount of the pigment among colors occurs, differences in evaporative power, and hygroscopicity power of water and difference in discharging property among colors occurs. The difference among the colors can be reduced by adjusting a moisturizing agent, the water content, the amount of a pigment, or viscosity. In particular, as an unused time of the recording apparatus in the same cap is longer, the nozzle clogging is unlikely to occur in a case of using the ink set according to the embodiment.

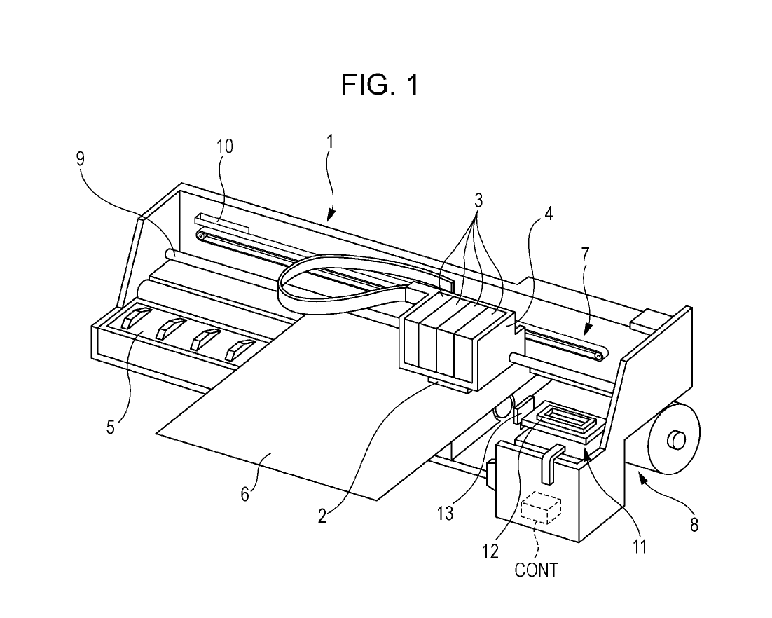

Hereinafter, one example of the ink jet recording apparatus capable of being obtained using the embodiment will be described with reference to FIGS. 1 to 3. Moreover, in each of the figures used for the description below, the scale of each member is appropriately changed since each member is required to be large enough to be recognizable. In the embodiment, an ink jet printer (hereinafter, referred to simply as “printer”) is exemplified as the ink jet recording apparatus.

FIG. 1 is a perspective view showing the configuration of the printer 1 in this embodiment. Moreover, printer 1 represents a serial printer. As shown in FIG. 1, the printer 1 has a carriage 4 in which an ink jet head 2 (recording head) is installed, and an ink cartridge 3 (ink container) is detachably mounted, a platen 5 disposed below the ink jet head 2 in which a recording medium 6 is transported, a carriage moving mechanism 7 which moves the carriage 4 in a medium width direction of the recording medium 6, and a medium feeding mechanism 8 which transports the recording medium 6 in a medium feeding direction. Further, the printer 1 has a controller CONT which controls entire operations of the printer 1. Moreover, the above-described medium width direction means a main scanning direction (head scanning direction). In addition, the above-described medium feeding direction means a sub-scanning direction (a direction orthogonal to the main scanning direction). In addition, the ink jet head 2 has a nozzle aperture 17 for each ink, the nozzle aperture 17 of each ink is capped with the same (that is one) cap member 12 (cap portion).

The ink cartridge 3 is not limited to those mounted to the carriage 4 as in the embodiment, and instead of this, for example, it may be a type supplied to the ink jet head 2 through an ink supply tube mounted on a housing side of the printer 1. The cyan ink, the magenta ink, the yellow ink, and the black ink and the specific ink capable of being provided in the ink set are contained in the ink cartridge 3.

The carriage 4 is attached in a state of being supported by a guide rod 9 which is a supporting member arranged in the main scanning direction. In addition, the carriage 4 is moved in the main scanning direction along with the guide rod 9 by the carriage moving mechanism 7.

A linear encoder 10 detects the position in the main scanning direction of the carriage 4 as a signal. The detected signal is transmitted to the controller CONT as position information. The controller CONT recognizes the scanning position of the ink jet head 2 based on the position information from the linear encoder 10, and controls the recording operation (discharge operation) by the ink jet head 2. In addition, the controller CONT has configuration which can variably control the movement speed of the carriage 4.

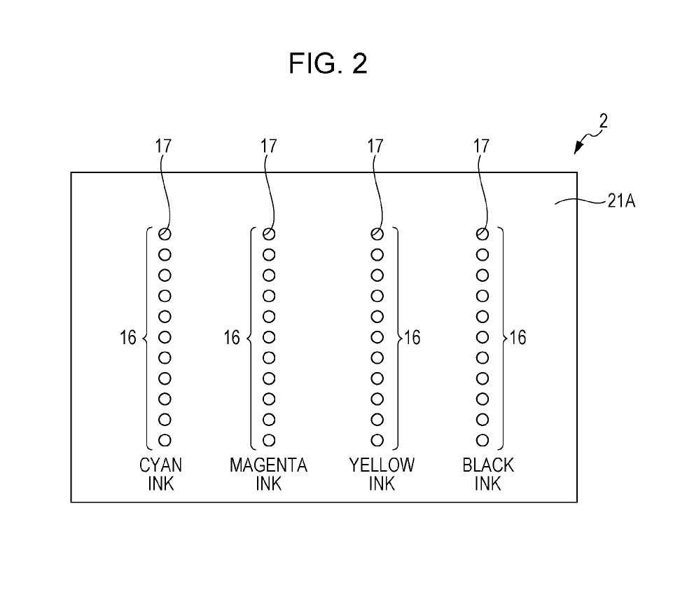

FIG. 2 is a schematic diagram showing array of nozzle apertures 17 provided to the ink jet head 2 according to the embodiment.

As shown in FIG. 2, the ink jet head 2 has a nozzle surface 21A provided with a plurality of the nozzle apertures 17 which discharges the ink. On the nozzle surface 21A, which is also a discharge surface of the ink, nozzle arrays 16 are formed at a plurality of the nozzle apertures 17. For example, the ink having a different composition can be discharged from each nozzle array 16. In the embodiment, four arrays, that is, nozzle array 16 (first ink), nozzle array 16 (second ink), nozzle array 16 (third ink), and nozzle array 16 (fourth ink), corresponding to the composition of the ink are provided. Each nozzle array 16 is configured with the nozzle apertures 17 of 180 apertures.

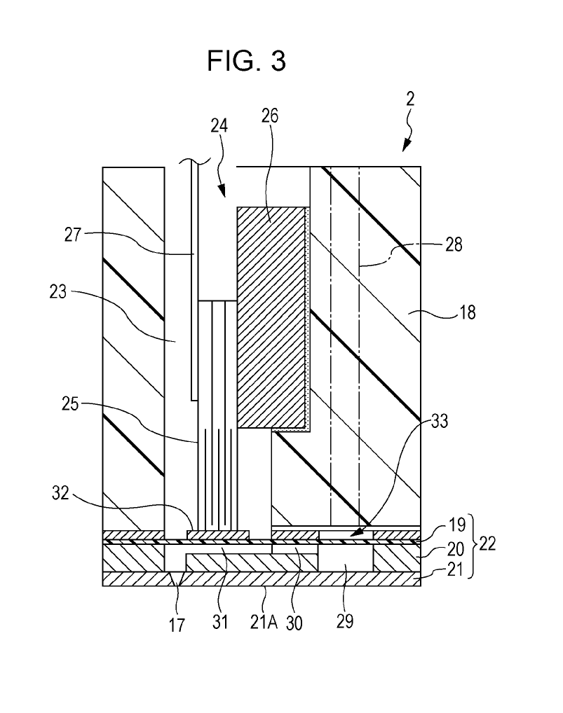

FIG. 3 is a partial cross-sectional view showing an internal configuration of the ink jet head 2 according to the embodiment.

As shown in FIG. 3, the ink jet head 2 has a head main body 18, and a channel-forming unit 22 which is connected to the head main body 18. In the channel-forming unit 22, a vibrating plate 19, a channel substrate 20, and a nozzle substrate 21 are provided, and a common ink chamber 29, an ink supply port 30, and a pressure chamber 31 are formed. Further, in the channel-forming unit 22, an island portion 32 which functions as a diaphragm portion, and compliance portion 33 for absorbing the pressure variation in the common ink chamber 29 are provided. In the head main body 18, a housing space 23 for accommodating a fixing member 26 and a driving unit 24, and internal channel 28 for guiding the ink to the channel-forming unit 22 are formed.

According to the above-described configuration, that is, the ink jet head 2 of a piezo type, when driving signal is input to the driving unit 24 through a cable 27, a piezoelectric element 25 expands and contracts. Thus, the vibrating plate 19 is deformed (moved) in the direction of approaching the pressure chamber 31 and in the direction away from the pressure chamber 31. Therefore, the volume of the pressure chamber 31 is changed, and the pressure of the pressure chamber 31 which contains the ink fluctuates. By the fluctuation in pressure, the ink is discharged from the nozzle aperture 17.

Referring back to FIG. 1, in the region of the outside of the platen 5 in the moving range of the ink jet head 2, a home position which is a scanning starting point of the ink jet head 2 is set. In the home position, a maintenance unit 11 is provided. The maintenance unit 11 is configured to perform a moisture retention operation in which evaporation of the ink by capping the ink jet head 2 with the cap member 12 (cap portion) is suppressed; a flushing operation in which by discharging the ink from each nozzle aperture 17 of the ink jet head 2 to the cap member 12 in advance, clogging of the nozzle aperture 17 due to a thickened ink is prevented, and the ink is normally discharged from the ink jet head 2 by adjusting the meniscus of the nozzle aperture 17; a suction operation (head cleaning) in which after capping the ink jet head 2 with the cap member 12, a suction pump (not shown) is driven, the highly thickened ink or attached dust are forcibly sucked from each nozzle aperture 17 to adjust the meniscus, and thus, the ink is normally discharged from the ink jet head 2; and a wiping operation in which by wiping the nozzle surface 21A (see FIG. 2) of the ink jet head 2 with a wipe member 13, the ink attached near the nozzle aperture 17 or the thickened ink is removed, or a purging treatment in which the meniscus of the nozzle aperture 17 is destroyed to readjust the meniscus is performed, other than printing operation.

### Examples

Hereinafter, the invention will be more specifically described using Examples and Comparative Examples. The invention is not limited to these Examples.

### Material for Ink

The main materials for the ink used in the following Examples and Comparative Examples are as follows.

### Pigment

### Carbon Black

### C. I. Pigment Blue 15:4

### C. I. Pigment Red 122

### C. I. Pigment Yellow 74

### Moisturizing Agent

### Glycerin

### Trimethylglycine

### Trimethylolpropane

### Surfactant

Olfine E1010 (acetylene glycol-based surfactant, manufactured by Nissin Chemical Industry Co., Ltd.)

### Penetrating Agent

1,2-hexanediol
Triethylene glycol monobutyl ether

### Resin

Acrylic ester polymer (T_{g}: −60° C., weight average molecular weight: 2000, manufactured by Toagosei Co., Ltd.)
Styrene-acrylic acid copolymer (T_{g}: 80° C., weight average molecular weight: 290000, manufactured by BASF Japan Co., Ltd.)

### Pyrrolidone Derivative

### 2-Pyrrolidone

### pH Adjusting Agent

### Tripropanolamine

### Preparation of Ink

Each material was mixed according to compositions (% by mass) shown in Tables 1 to 4 described below, and the mixtures were sufficiently stirred, thereby obtaining cyan inks C1-A to C10-A, magenta inks M1-A to M10-A, yellow inks Y1-A to Y10-A, black inks K1-B to K10-B, cyan inks C1-B to C10-B, magenta inks M1-B to M10-B, and yellow ink Y1-B to Y10-B, respectively. Each ink obtained was combined as an ink set shown in Tables 1 to 4, and the resultant products were used in Examples and Comparative Examples.

### Measurement Method of Viscosity

Stable values at the measurement temperature of 20° C. were read as a viscosity of each ink using a vibration-type viscometer (VM-100 manufactured by YMAICHI ELECTRONICS). Examples 1A to 5A, Comparative Examples 1A to 6a, Examples 1B to 4B, and Comparative Examples 1B to 6B

As an ink jet recording apparatus, PX-B510 (manufactured by Seiko Epson Corporation) was used. The PX-B510 is provided with an ink cartridge which contains each ink of an ink set, an ink jet head having nozzles, and a cap portion which caps the nozzles with the same cap.

### Evaluation of Clogging Recoverability

Each ink set obtained above was filled in the ink cartridge of the PX-B510 and mounted. Next, using a printer driver, the ink was filled in the head of the printer, and it was confirmed that no nozzles were clogged, and normal recording was possible. Then, according to normal instructions for use, the switch was pressed to turn off the power, and the power cord was unplugged. In this manner, in a normal state where the ink cartridge and the head cap were mounted, the PX-B510 was left to stand for one month in an environment of 40° C. and 45 RH %.

After being left alone, the power of the printer was turned on, an initial cleaning was performed after turning on, and a clogging recoverability was evaluated according to the following evaluation criteria.

### Evaluation Criteria

A: After the initial flushing after turning on, nozzle omission does not occur.
C: After the initial flushing after turning on, nozzle omission occurs.

### Evaluation of Discharging Stability

In the same manner as “evaluation of clogging recoverability” described above, after the PX-B510 was left to stand for one month in an environment of 40° C. and 45 RH %, the power of the printer was turned on, an initial cleaning was performed after turning on, and a ruled line pattern was printed. For the obtained ruled line pattern, the deviation amount of the ruled lines was measured with an optical microscope, and the discharging stability was evaluated by the following evaluation criteria.

### Evaluation Criteria

A: Deviation amount of the ruled lines is equal to or greater than 80 μm
B: Deviation amount of the ruled lines is less than 80 μm

### Coloring Property

Each ink set obtained above was filled in the ink cartridge of the PX-B510 and mounted. Next, using the printer driver, the ink was filled in the head of the printer, and it was confirmed that no nozzles were clogged, and normal recording was possible. Next, a solid pattern of each ink was recorded on a XEROX 4200 paper which is a recording medium, respectively. OD value of the obtained recorded material was measured with an SPM50 colorimeter manufactured by GretagMacbeth, and a coloring property was evaluated. The evaluation criteria are shown below.

### Evaluation Criteria

A: OD value of all solid patterns is equal to or greater than 0.9
C: OD value of at least one solid pattern is less than 0.8

TABLE 1

| | | Example 1A | | | Example 2A | | | Example 3A | | |
|---|---|---|---|---|---|---|---|---|---|---|
| | | C1-A | M1-A | Y1-A | C2-A | M2-A | Y2-A | C3-A | M3-A | Y3-A |
| Pigment | | 5 | 8 | 6 | 5 | 8 | 6 | 5 | 8 | 6 |
| Water | | 57 | 58 | 57 | 57 | 58 | 57 | 59 | 61 | 59 |
| Moisturizing Agent | Glycerin | 6 | 8 | 7 | 6 | 8 | 7 | 6 | 8 | 7 |
| | Trimethylglycine | 10 | 10 | 10 | 10 | 10 | 10 | 10 | 10 | 10 |
| | Trimethylolpropane | 9 | 5 | 5 | 9 | 5 | 4 | 9 | 5 | 5 |
| Surfactant | Olfine E1010 | 0.5 | 0.5 | 0.5 | 0.5 | 0.5 | 0.5 | 0.5 | 0.5 | 0.5 |
| Penetrating agent | 1,2-hexanediol | 2.5 | 2.5 | 2.5 | 2.5 | 2.5 | 2.5 | 2.5 | 2.5 | 2.5 |
| Resin | Acrylic ester resin | 1 | 1 | 1 | 1 | 1 | 1 | 1 | 1 | 1 |
| | Styrene-acrylic acid | 1 | 1 | 1 | 1 | 1 | 1 | 1 | 1 | 1 |
| | copolymer | | | | | | | | | |
| Other | Triethylene glycol | 2 | 2 | 2 | 2 | 2 | 2 | 2 | 2 | 2 |
| | monobutyl ether | | | | | | | | | |
| Pyrrolidone | 2-Pyrrolidone | 5.5 | 3.5 | 7.5 | 5.5 | 3.5 | 7.5 | 3.5 | 0.5 | 5.5 |
| Derivative | | | | | | | | | | |
| pH adjusting agent | Tripropanolamine | 0.5 | 0.5 | 0.5 | 0.5 | 0.5 | 0.5 | 0.5 | 0.5 | 0.5 |

| Total | 100 | 100 | 100 | 100 | 100 | 99 | 100 | 100 | 100 |
|---|---|---|---|---|---|---|---|---|---|
| Viscosity | 6.8 | 6.4 | 6.4 | 6.8 | 6.4 | 6.3 | 6.3 | 6 | 6.2 |
| Evaluation of clogging recoverability | A | A | A | A | A | A | A | A | A |
| Evaluation of discharging stability | A | A | A | A | B | A | A | B | A |
| Coloring property | A | A | A | A | A | A | A | A | A |
| Maximum pigment-minimum pigment | 3 | | | 3 | | | 3 | | |
| Maximum water-minimum water | 1 | | | 1 | | | 2 | | |
| Ink of which pigment content is maximum | M1-A | | | M2-A | | | M3-A | | |
| Ink of which water content is maximum | M1-A | | | M2-A | | | M3-A | | |
| Ink of which total content of glycerin and | M1-A | | | M2-A | | | M3-A | | |
| trimethylglycine is maximum | | | | | | | | | |
| Pigment + trimethylolpropane | 14 | 13 | 11 | 14 | 13 | 10 | 14 | 13 | 11 |
| MAX-MIN | 3 | | | 4 | | | 3 | | |
| Water content | 57 | 58 | 57 | 57 | 58 | 57 | 59 | 61 | 59 |

| | | Example 4A | | | Example 5A | | | | |
|---|---|---|---|---|---|---|---|---|---|
| | | C4-A | M4-A | Y4-A | C1-A | M1-A | Y1-A | B1-A | R1-A |
| Pigment | | 5 | 8 | 6 | 5 | 8 | 6 | 5 | 8 |
| Water | | 49 | 50 | 49 | 57 | 58 | 57 | 57 | 58 |
| Moisturizing Agent | Glycerin | 6 | 8 | 7 | 6 | 8 | 7 | 6 | 8 |
| | Trimethylglycine | 10 | 10 | 10 | 10 | 10 | 10 | 10 | 10 |
| | Trimethylolpropane | 9 | 5 | 5 | 9 | 5 | 5 | 9 | 5 |
| Surfactant | Olfine E1010 | 0.5 | 0.5 | 0.5 | 0.5 | 0.5 | 0.5 | 0.5 | 0.5 |
| Penetrating agent | 1,2-hexanediol | 2.5 | 2.5 | 2.5 | 2.5 | 2.5 | 2.5 | 2.5 | 2.5 |
| Resin | Acrylic ester resin | 1 | 1 | 1 | 1 | 1 | 1 | 1 | 1 |
| | Styrene-acrylic acid | 1 | 1 | 1 | 1 | 1 | 1 | 1 | 1 |
| | copolymer | | | | | | | | |
| Other | Triethylene glycol | 2 | 2 | 2 | 2 | 2 | 2 | 2 | 2 |
| | monobutyl ether | | | | | | | | |
| Pyrrolidone | 2-Pyrrolidone | 13.5 | 11.5 | 15.5 | 5.5 | 3.5 | 7.5 | 5.5 | 3.5 |
| Derivative | | | | | | | | | |
| pH adjusting agent | Tripropanolamine | 0.5 | 0.5 | 0.5 | 0.5 | 0.5 | 0.5 | 0.5 | 0.5 |

| Total | 100 | 100 | 100 | 100 | 100 | 100 | 100 | 100 |
|---|---|---|---|---|---|---|---|---|
| Viscosity | 13.6 | 13 | 14 | 6.8 | 6.4 | 6.4 | 7 | 7.2 |
| Evaluation of clogging recoverability | A | A | A | A | A | A | A | A |
| Evaluation of discharging stability | A | B | A | A | A | A | A | A |
| Coloring property | A | A | A | A | A | A | A | A |
| Maximum pigment-minimum pigment | 3 | | | 3 | | | | |
| Maximum water-minimum water | 1 | | | 1 | | | | |
| Ink of which pigment content is maximum | M4-A | | | M1-A, R1-A | | | | |
| Ink of which water content is maximum | M4-A | | | M1-A, R1-A | | | | |
| Ink of which total content of glycerin and | M4-A | | | M1-A, R1-A | | | | |
| trimethylglycine is maximum | | | | | | | | |
| Pigment + trimethylolpropane | 14 | 13 | 11 | 14 | 13 | 11 | 14 | 13 |
| MAX-MIN | 3 | | | 3 | | | | |
| Water content | 49 | 50 | 49 | 57 | 58 | 57 | 57 | 58 |

TABLE 2

| | | Comp. Ex. 1A | | | Comp. Ex. 2A | | | Comp. Ex. 3A | | |
|---|---|---|---|---|---|---|---|---|---|---|
| | | C5-A | M5-A | Y5-A | C6-A | M6-A | Y6-A | C7-A | M7-A | Y7-A |
| Pigment | | 5 | 8 | 6 | 5 | 8 | 6 | 5 | 8 | 6 |
| Water | | 57 | 58 | 57 | 57 | 58 | 57 | 57 | 58 | 54 |
| Moisturizing Agent | Glycerin | 16 | 18 | 17 | 0 | 0 | 0 | 6 | 8 | 7 |
| | Trimethylglycine | 0 | 0 | 0 | 16 | 18 | 17 | 10 | 10 | 10 |
| | Trimethylolpropane | 9 | 5 | 5 | 9 | 5 | 5 | 9 | 5 | 5 |
| Surfactant | Olfine E1010 | 0.5 | 0.5 | 0.5 | 0.5 | 0.5 | 0.5 | 0.5 | 0.5 | 0.5 |
| Penetrating agent | 1,2-hexanediol | 2.5 | 2.5 | 2.5 | 2.5 | 2.5 | 2.5 | 2.5 | 2.5 | 2.5 |
| Resin | Acrylic ester resin | 1 | 1 | 1 | 1 | 1 | 1 | 1 | 1 | 1 |
| | Styrene-acrylic acid | 1 | 1 | 1 | 1 | 1 | 1 | 1 | 1 | 1 |
| | copolymer | | | | | | | | | |
| Other | Triethylene glycol | 2 | 2 | 2 | 2 | 2 | 2 | 2 | 2 | 2 |
| | monobutyl ether | | | | | | | | | |
| Pyrrolidone | 2-Pyrrolidone | 5.5 | 3.5 | 7.5 | 5.5 | 3.5 | 7.5 | 5.5 | 3.5 | 10.5 |
| Derivative | | | | | | | | | | |
| pH adjusting agent | Tripropanolamine | 0.5 | 0.5 | 0.5 | 0.5 | 0.5 | 0.5 | 0.5 | 0.5 | 0.5 |

| Total | 100 | 100 | 100 | 100 | 100 | 100 | 100 | 100 | 100 |
|---|---|---|---|---|---|---|---|---|---|
| Viscosity | 6.9 | 6.6 | 6.5 | 6.7 | 6.4 | 6.3 | 6.8 | 6.6 | 6.7 |
| Evaluation of clogging recoverability | A | C | A | C | C | C | A | C | A |
| Evaluation of discharging stability | A | B | A | B | B | B | B | B | A |
| Coloring property | A | A | A | A | A | A | A | A | A |
| Maximum pigment-minimum pigment | 3 | | | 3 | | | 3 | | |
| Maximum water-minimum water | 1 | | | 1 | | | 4 | | |
| Ink of which pigment content is maximum | M5-A | | | M6-A | | | M7-A | | |
| Ink of which water content is maximum | M5-A | | | M6-A | | | M7-A | | |
| Ink of which total content of glycerin and | M5-A | | | M6-A | | | M7-A | | |
| trimethylglycine is maximum | | | | | | | | | |
| Pigment + trimethylolpropane | 14 | 13 | 11 | 14 | 13 | 11 | 14 | 13 | 11 |
| MAX-MIN | 3 | | | 3 | | | 3 | | |
| Water content | 57 | 58 | 57 | 57 | 58 | 57 | 57 | 58 | 54 |

| | | Comp. Ex. 4A | | | Comp. Ex. 5A | | | Comp. Ex. 6A | | |
|---|---|---|---|---|---|---|---|---|---|---|
| | | C8- | M8- | Y8- | C9- | M9- | Y9- | C10- | M10- | Y10- |
| | | A | A | A | A | A | A | A | A | A |
| Pigment | | 5 | 8 | 6 | 5 | 8 | 6 | 5 | 8 | 6 |
| Water | | 57 | 54 | 57 | 57 | 58 | 57 | 57 | 57 | 57 |
| Moisturizing Agent | Glycerin | 6 | 8 | 7 | 6 | 5 | 7 | 0 | 0 | 0 |
| | Trimethylglycine | 10 | 10 | 10 | 10 | 10 | 10 | 10 | 11 | 10 |
| | Trimethylolpropane | 9 | 5 | 5 | 9 | 5 | 5 | 9 | 5 | 5 |
| Surfactant | Olfine E1010 | 0.5 | 0.5 | 0.5 | 0.5 | 0.5 | 0.5 | 0.5 | 0.5 | 0.5 |
| Penetrating agent | 1,2-hexanediol | 2.5 | 2.5 | 2.5 | 2.5 | 2.5 | 2.5 | 2.5 | 2.5 | 2.5 |
| Resin | Acrylic ester resin | 1 | 1 | 1 | 1 | 1 | 1 | 1 | 1 | 1 |
| | Styrene-acrylic acid | 1 | 1 | 1 | 1 | 1 | 1 | 1 | 1 | 1 |
| | copolymer | | | | | | | | | |
| Other | Triethylene glycol | 2 | 2 | 2 | 2 | 2 | 2 | 2 | 2 | 2 |
| | monobutyl ether | | | | | | | | | |
| Pyrrolidone | 2-Pyrrolidone | 6.5 | 7.5 | 7.5 | 5.5 | 6.5 | 7.5 | 11.5 | 11.5 | 14.5 |
| Derivative | | | | | | | | | | |
| pH adjusting agent | Tripropanolamine | 0.5 | 0.5 | 0.5 | 0.5 | 0.5 | 0.5 | 0.5 | 0.5 | 0.5 |

| Total | 100 | 100 | 100 | 100 | 100 | 100 | 100 | 100 | 100 |
|---|---|---|---|---|---|---|---|---|---|
| Viscosity | 6.8 | 7 | 6.4 | 6.8 | 6.5 | 6.4 | 7 | 6.8 | 6.6 |
| Evaluation of clogging recoverability | A | C | C | A | C | A | C | C | C |
| Evaluation of discharging stability | A | B | B | A | B | A | B | B | B |
| Coloring property | A | A | A | A | A | A | A | A | A |
| Maximum pigment-minimum pigment | 3 | | | 3 | | | 3 | | |
| Maximum water-minimum water | 3 | | | 1 | | | 0 | | |
| Ink of which pigment content is maximum | M8-A | | | M9-A | | | M10-A | | |
| Ink of which water content is maximum | C8-A | | | M9-A | | | C10-A | | |
| Ink of which total content of glycerin and | M8-A | | | Y9-A | | | M10-A | | |
| trimethylglycine is maximum | | | | | | | | | |
| Pigment + trimethylolpropane | 14 | 13 | 11 | 14 | 13 | 11 | 14 | 13 | 11 |
| MAX-MIN | 3 | | | 3 | | | 3 | | |
| Water content | 57 | 54 | 57 | 57 | 58 | 57 | 57 | 57 | 57 |

TABLE 3

| | | Example 1B | | | | Example 2B | | | | Example 3B | | | | Example 4B | | | |
|---|---|---|---|---|---|---|---|---|---|---|---|---|---|---|---|---|---|
| | | K1-B | C1-B | M1-B | Y1-B | K2-B | C2-B | M2-B | Y2-B | K3-B | C3-B | M3-B | Y3-B | K4-B | C4-B | M4-B | Y4-B |
| Pigment | | 9 | 5 | 8 | 6 | 9 | 5 | 8 | 6 | 9 | 5 | 8 | 6 | 9 | 5 | 8 | 6 |
| Water | | 59 | 57 | 57 | 57 | 59 | 57 | 57 | 58 | 61 | 59 | 59 | 59 | 51 | 49 | 49 | 49 |
| Moistur- | Glycerin | 10 | 6 | 8 | 7 | 10 | 6 | 8 | 7 | 10 | 6 | 8 | 7 | 10 | 6 | 8 | 7 |
| izing | Trimethyl- | 10 | 10 | 10 | 10 | 10 | 10 | 10 | 10 | 10 | 10 | 10 | 10 | 10 | 10 | 10 | 10 |
| Agent | glycine | | | | | | | | | | | | | | | | |
| | Trimethylol- | 4 | 9 | 5 | 5 | 4 | 9 | 5 | 4 | 4 | 9 | 5 | 5 | 4 | 9 | 5 | 5 |
| | propane | | | | | | | | | | | | | | | | |
| Surfactant | Olfine | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| | E1010 | | | | | | | | | | | | | | | | |
| Penetrat- | 1,2- | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 | 2.5 |
| ing agent | hexanediol | | | | | | | | | | | | | | | | |
| Resin | Acrylic ester | 1 | 1 | 1 | 1 | 1 | 1 | 1 | 1 | 1 | 1 | 1 | 1 | 1 | 1 | 1 | 1 |
| | resin | | | | | | | | | | | | | | | | |
| | Styrene- | 1 | 1 | 1 | 1 | 1 | 1 | 1 | 1 | 1 | 1 | 1 | 1 | 1 | 1 | 1 | 1 |
| | acrylic | | | | | | | | | | | | | | | | |
| | acid co- | | | | | | | | | | | | | | | | |
| | polymer | | | | | | | | | | | | | | | | |
| Other | Triethylene | 1 | 2 | 2 | 2 | 1 | 2 | 2 | 2 | 0.5 | 2 | 2 | 2 | 0.5 | 2 | 2 | 2 |
| | glycol mono- | | | | | | | | | | | | | | | | |
| | butyl ether | | | | | | | | | | | | | | | | |
| Pyrrolidone | 2- | 1.5 | 5.5 | 4.5 | 7.5 | 1.5 | 5.5 | 4.5 | 7.5 | 0 | 3.5 | 2.5 | 5.5 | 10 | 13.5 | 12.5 | 15.5 |
| Derivative | Pyrrolidone | | | | | | | | | | | | | | | | |
| pH adjusting | Tripropanol- | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| agent | amine | | | | | | | | | | | | | | | | |

| Total | 100 | 100 | 100 | 100 | 100 | 100 | 100 | 100 | 100 | 100 | 100 | 100 | 100 | 100 | 100 | 100 |
|---|---|---|---|---|---|---|---|---|---|---|---|---|---|---|---|---|
| Viscosity | 7.3 | 6.8 | 6.6 | 6.4 | 7.3 | 6.8 | 6.6 | 6.2 | 6.8 | 6.3 | 6 | 6.2 | 14.5 | 13.6 | 14 | 14 |
| Evaluation of clogging | A | A | A | A | A | A | A | A | A | A | A | A | A | A | A | A |
| recoverability | | | | | | | | | | | | | | | | |
| Evaluation of discharging | A | A | A | A | B | A | A | A | B | A | A | A | B | B | B | B |
| stability | | | | | | | | | | | | | | | | |
| Coloring property | A | A | A | A | A | A | A | A | A | A | A | A | A | A | A | A |
| Maximum pigment-minimum | 4 | | | | 4 | | | | 4 | | | | 4 | | | |
| pigment | | | | | | | | | | | | | | | | |
| Maximum water-minimum | 2 | | | | 2 | | | | 2 | | | | 2 | | | |
| water | | | | | | | | | | | | | | | | |
| Ink of which pigment | K1-B | | | | K2-B | | | | K3-B | | | | K4-B | | | |
| content is maximum | | | | | | | | | | | | | | | | |
| Ink of which water | K1-B | | | | K2-B | | | | K3-B | | | | K4-B | | | |
| content is maximum | | | | | | | | | | | | | | | | |
| Ink of which total | K1-B | | | | K2-B | | | | K3-B | | | | K4-B | | | |
| content of glycerin | | | | | | | | | | | | | | | | |
| and trimethylglycine | | | | | | | | | | | | | | | | |
| is maximum | | | | | | | | | | | | | | | | |
| Pigment + tri- | 13 | 14 | 13 | 11 | 13 | 14 | 13 | 10 | 13 | 14 | 13 | 11 | 13 | 14 | 13 | 11 |
| methylolpropane | | | | | | | | | | | | | | | | |
| MAX-MIN | 3 | | | | 4 | | | | 3 | | | | 3 | | | |
| Water content | 59 | 57 | 57 | 57 | 59 | 57 | 57 | 58 | 61 | 59 | 59 | 59 | 51 | 49 | 49 | 49 |

TABLE 4

| | | Comp. Ex. 1B | | | | Comp. Ex. 2B | | | | Comp. Ex. 3B | | | |
|---|---|---|---|---|---|---|---|---|---|---|---|---|---|
| | | K5-B | C5-B | M5-B | Y5-B | K6-B | C6-B | M6-B | Y6-B | K7-B | C7-B | M7-B | Y7-B |
| Pigment | | 9 | 5 | 8 | 6 | 9 | 5 | 8 | 6 | 9 | 5 | 8 | 6 |
| Water | | 59 | 57 | 57 | 57 | 59 | 57 | 57 | 57 | 59 | 57 | 55 | 57 |
| Moisturizing Agent | Glycerin | 20 | 16 | 18 | 17 | 0 | 0 | 0 | 0 | 10 | 6 | 8 | 7 |
| | Trimethylglycine | 0 | 0 | 0 | 0 | 20 | 16 | 18 | 17 | 10 | 10 | 10 | 10 |
| | Trimethylolpropane | 4 | 9 | 5 | 5 | 4 | 9 | 5 | 5 | 4 | 9 | 5 | 5 |
| Surfactant | Olfine E1010 | 0.5 | 0.5 | 0.5 | 0.5 | 0.5 | 0.5 | 0.5 | 0.5 | 0.5 | 0.5 | 0.5 | 0.5 |
| Penetrating agent | 1,2-hexanediol | 2.5 | 2.5 | 2.5 | 2.5 | 2.5 | 2.5 | 2.5 | 2.5 | 2.5 | 2.5 | 2.5 | 2.5 |
| Resin | Acrylic ester resin | 1 | 1 | 1 | 1 | 1 | 1 | 1 | 1 | 1 | 1 | 1 | 1 |
| | Styrene-acrylic acid | 1 | 1 | 1 | 1 | 1 | 1 | 1 | 1 | 1 | 1 | 1 | 1 |
| | copolymer | | | | | | | | | | | | |
| Other | Triethylene glycol | 2 | 2 | 2 | 2 | 2 | 2 | 2 | 2 | 2 | 2 | 2 | 2 |
| | monobutyl ether | | | | | | | | | | | | |
| Pyrrolidone | 2-Pyrrolidone | 0.5 | 5.5 | 4.5 | 7.5 | 0.5 | 5.5 | 4.5 | 7.5 | 0.5 | 5.5 | 6.5 | 7.5 |
| Derivative | | | | | | | | | | | | | |
| pH adjusting agent | Tripropanolamine | 0.5 | 0.5 | 0.5 | 0.5 | 0.5 | 0.5 | 0.5 | 0.5 | 0.5 | 0.5 | 0.5 | 0.5 |
| Total | | 100 | 100 | 100 | 100 | 100 | 100 | 100 | 100 | 100 | 100 | 100 | 100 |
| Viscosity | | 7.4 | 6.9 | 6.7 | 6.5 | 7.2 | 6.7 | 6.5 | 6.3 | 7.3 | 6.8 | 7 | 6.4 |
| Evaluation of clogging recoverability | | C | A | A | A | C | C | C | C | C | A | A | A |
| Evaluation of discharging stability | | B | A | A | A | B | B | B | B | B | A | A | A |
| Coloring property | | A | A | A | A | A | A | A | A | A | A | A | A |
| Maximum pigment-minimum pigment | | 4 | | | | 4 | | | | 4 | | | |
| Maximum water-minimum water | | 2 | | | | 2 | | | | 4 | | | |
| Ink of which pigment content is maximum | | K5-B | | | | K6-B | | | | K7-B | | | |
| Ink of which water content is maximum | | K5-B | | | | K6-B | | | | K7-B | | | |
| Ink of which total content of glycerin | | K5-B | | | | K6-B | | | | K7-B | | | |
| and trimethylglycine is maximum | | | | | | | | | | | | | |
| Pigment + trimethylolpropane | | 13 | 14 | 13 | 11 | 13 | 14 | 13 | 11 | 13 | 14 | 13 | 11 |
| MAX-MIN | | 3 | | | | 3 | | | | 3 | | | |
| Water content | | 59 | 57 | 57 | 57 | 59 | 57 | 57 | 57 | 59 | 57 | 55 | 57 |
| | | Comp. Ex. 4B | | | | Comp. Ex. 5B | | | | Comp. Ex. 6B | | | |
| | | K8- | C8- | M8- | Y8- | K9- | C9- | M9- | Y9- | K10- | C10- | M10- | Y10- |
| | | B | B | B | B | B | B | B | B | B | B | B | B |
| Pigment | | 9 | 5 | 8 | 6 | 9 | 5 | 8 | 6 | 9 | 5 | 8 | 5 |
| Water | | 54 | 57 | 57 | 57 | 59 | 57 | 57 | 57 | 59 | 57 | 57 | 57 |
| Moisturizing Agent | Glycerin | 10 | 6 | 8 | 7 | 6 | 6 | 8 | 7 | 0 | 0 | 0 | 0 |
| | Trimethylglycine | 10 | 10 | 10 | 10 | 10 | 10 | 10 | 10 | 11 | 10 | 10 | 10 |
| | Trimethylolpropane | 4 | 9 | 5 | 5 | 4 | 9 | 5 | 5 | 4 | 9 | 5 | 5 |
| Surfactant | Olfine E1010 | 0.5 | 0.5 | 0.5 | 0.5 | 0.5 | 0.5 | 0.5 | 0.5 | 0.5 | 0.5 | 0.5 | 0.5 |
| Penetrating agent | 1,2-hexanediol | 2.5 | 2.5 | 2.5 | 2.5 | 2.5 | 2.5 | 2.5 | 2.5 | 2.5 | 2.5 | 2.5 | 2.5 |
| Resin | Acrylic ester resin | 1 | 1 | 1 | 1 | 1 | 1 | 1 | 1 | 1 | 1 | 1 | 1 |
| | Styrene-acrylic acid | 1 | 1 | 1 | 1 | 1 | 1 | 1 | 1 | 1 | 1 | 1 | 1 |
| | copolymer | | | | | | | | | | | | |
| Other | Triethylene glycol | 2 | 2 | 2 | 2 | 2 | 2 | 2 | 2 | 2 | 2 | 2 | 2 |
| | monobutyl ether | | | | | | | | | | | | |
| Pyrrolidone | 2-Pyrrolidone | 5.5 | 6.5 | 4.5 | 7.5 | 4.5 | 5.5 | 4.5 | 7.5 | 9.5 | 11.5 | 12.5 | 14.5 |
| Derivative | | | | | | | | | | | | | |
| pH adjusting agent | Tripropanolamine | 0.5 | 0.5 | 0.5 | 0.5 | 0.5 | 0.5 | 0.5 | 0.5 | 0.5 | 0.5 | 0.5 | 0.5 |

| Total | 100 | 100 | 100 | 100 | 100 | 100 | 100 | 100 | 100 | 100 | 100 | 100 |
|---|---|---|---|---|---|---|---|---|---|---|---|---|
| Viscosity | 10.2 | 6.8 | 6.6 | 6.4 | 7.5 | 6.8 | 6.6 | 6.4 | 7.5 | 7 | 6.8 | 6.6 |
| Evaluation of clogging recoverability | C | A | C | A | C | A | A | A | C | C | C | C |
| Evaluation of discharging stability | B | A | B | A | B | A | A | A | B | B | B | B |
| Coloring property | A | A | A | A | A | A | A | A | A | A | A | C |
| Maximum pigment-minimum pigment | 4 | | | | 4 | | | | 4 | | | |
| Maximum water-minimum water | 3 | | | | 2 | | | | 2 | | | |
| Ink of which pigment content is maximum | K8-B | | | | K9-B | | | | K10-B | | | |
| Ink of which water content is maximum | C8-B | | | | K9-B | | | | K10-B | | | |
| Ink of which total content of glycerin | K8-B | | | | M9-B | | | | K10-B | | | |
| and trimethylglycine is maximum | | | | | | | | | | | | |
| Pigment + trimethylolpropane | 13 | 14 | 13 | 11 | 13 | 14 | 13 | 11 | 13 | 14 | 13 | 11 |
| MAX-MIN | 3 | | | | 3 | | | | 3 | | | |
| Water content | 54 | 57 | 57 | 57 | 59 | 57 | 57 | 57 | 59 | 57 | 57 | 57 |

As described above, according to the invention, it was found that the ink set of which the coloring property is excellent, and the clogging recoverability and the discharging stability are excellent can be provided. In addition, from the comparison of Examples 1A and 2A, it was found that when the maximum difference of the total content ratio of the pigment and the trimethylolpropane with respect to 100% by mass of the total amount of each ink is equal to or less than 3.0% by mass, the discharging stability is more excellent. In addition, from the comparison of Examples 1A, 3A, and 4A, it was found that when the content ratio of water in each ink is 50% by mass to 60% by mass with respect to 100% by mass of the total amount of each of the ink, the discharging stability is more excellent.

In addition, from the comparison of Examples 1B and 2B, it was found that when the maximum difference in the viscosity of each ink is equal to or less than 1.0 mPa·s, the discharging stability is more excellent. In addition, from the comparison of Examples 1B, 3B, and 4B, it was found that when the content ratio of water in each ink is 50% by mass to 60% by mass with respect to 100% by mass of the total amount of each of the ink, the discharging stability is more excellent.

The entire disclosure of Japanese Patent Application No. 2013-148699, filed Jul. 17, 2013 is expressly incorporated by reference herein.

What is claimed is:

1. An ink set comprising at least:
a cyan ink;
a magenta ink; and
a yellow ink,
wherein each ink provided in the ink set includes water, a pigment of equal to or greater than 5% by mass with respect to 100% by mass of a total amount of each of the ink, glycerin, and a betaine compound having a molecular weight of less than 120, respectively.
wherein in each of the ink, a maximum difference in a content ratio of the pigment is equal to or greater than 3.0% by mass, and a maximum difference in a content ratio of the water is equal to or less than 3.0% by mass, and
wherein in each of the ink, the ink in which the content ratio of the pigment is at a maximum, the ink in which the content ratio of the water is at a maximum, and the ink in which a total content ratio of the glycerin and the betaine compound is at a maximum are the same ink.

2. The ink set according to claim 1, further comprising:
a black ink,
wherein the black ink includes the water, the pigment of equal to or greater than 5.0% by mass with respect to 100% by mass of a total amount of the black ink, the glycerin, and the betaine compound having a molecular weight of less than 120.

3. The ink set according to claim 1,
wherein a maximum viscosity difference of each of the ink is equal to or less than 1.0 mPa·s.

4. The ink set according to claim 1,
wherein at least one of each of the ink further including trimethylolpropane, and among each of the ink, a maximum difference of the total content ratio of the pigment and the trimethylolpropane with respect to 100% by mass of a total amount of each of the ink is equal to or less than 3.0% by mass.

5. The ink set according to claim 1,
wherein a content ratio of the water in each of the ink is 50% by mass to 60% by mass with respect to 100% by mass of the total amount of each of the ink.

6. The ink set according to claim 1 further comprising:
one or more kinds of specific inks,
wherein the specific ink has a color which has difference of equal to or greater than 30° from any of each color that each of the ink has.

7. An ink jet recording apparatus comprising:
an ink container containing the ink set according to claim 1;
a recording head having nozzles for discharging each ink provided in the ink set; and
a cap portion capping the nozzles with the same cap.

8. An ink jet recording apparatus comprising:
an ink container containing the ink set according to claim 2;
a recording head having nozzles for discharging each ink provided in the ink set; and
a cap portion capping the nozzles with the same cap.

9. An ink jet recording apparatus comprising:
an ink container containing the ink set according to claim 3;
a recording head having nozzles for discharging each ink provided in the ink set; and
a cap portion capping the nozzles with the same cap.

10. An ink jet recording apparatus comprising:
an ink container containing the ink set according to claim 4;
a recording head having nozzles for discharging each ink provided in the ink set; and
a cap portion capping the nozzles with the same cap.

11. An ink jet recording apparatus comprising:
an ink container containing the ink set according to claim 5;
a recording head having nozzles for discharging each ink provided in the ink set; and
a cap portion capping the nozzles with the same cap.

12. An ink jet recording apparatus comprising:
an ink container containing the ink set according to claim 6;
a recording head having nozzles for discharging each ink provided in the ink set; and
a cap portion capping the nozzles with the same cap.
